(19) United States
(12) Patent Application Publication
(10) Pub. No.: US 2008/0082338 A1
(43) Pub. Date: Apr. 3, 2008

(54) Systems and methods for secure voice identification and medical device interface

(76) Inventors: Michael P. O'Neil, Pleasanton, CA (US); Lutz Andersohn, Livermore, CA (US); Paul D. Mannheimer, Danville, CA (US); Roger Mecca, Danville, CA (US)

Correspondence Address: Covidien;IP Counsel - Respiratory & Monitoring Solutions, 60 Middletown Avenue, North Haven, CT, 06473, US

(21) Appl. No.: 11/540,015

(22) Filed: Sep. 29, 2006

(51) Int. Cl. G10L 21/00

(52) U.S. Cl. 704/275

(57) ABSTRACT

There is provided a system and method for secure voice identification and medical device interface. More specifically, in one embodiment, there is provided a medical device comprising an audio recognition system configured to receive an unlock keyword for the medical device and to unlock the medical device to voice commands in response to the unlock keyword, and a control system coupled to the audio recognition system configured to execute one or more voice commands on the medical device after the medical device is unlocked.

### BACKGROUND OF THE INVENTION

1. Field of the Invention

The present invention relates generally to medical devices and, more particularly, to secure voice identification and interface in such medical devices.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the field of medicine, doctors often desire to monitor certain physiological characteristics of their patients. Accordingly, a wide variety of medical devices have been developed for monitoring physiological characteristics. Such devices provide caregivers, such as doctors, nurses, and/or other healthcare personnel, with the information they need to provide the best possible healthcare for their patients. As a result, such monitoring devices have become an indispensable part of modern medicine.

For example, one technique for monitoring certain physiological characteristics of a patient is commonly referred to as pulse oximetry, and the devices built based upon pulse oximetry techniques are commonly referred to as pulse oximeters. Pulse oximetry may be used to measure various blood flow characteristics, such as the oxygen saturation of hemoglobin in arterial blood, the volume of individual blood pulsations supplying the tissue, and/or the rate of blood pulsations corresponding to each heartbeat of a patient.

Pulse oximeters and other types of medical devices are typically mounted on stands that are positioned around a patient's bed or around an operating room table. When a caregiver desires to command the medical device (e.g., program, configure, and so-forth) they manipulate controls or push buttons on the medical device itself. The medical device typically provides results or responses to commands on a liquid crystal display (“LCD”) screen mounted in an externally visible position within the medical device.

This conventional configuration, however, has several disadvantages. First, as described above, this conventional configuration relies upon physical contact with the medical device to input commands (e.g., pushing a button, turning a knob, and the like). Such physical contact, however, raises several concerns. Among these concerns are that in making contact with the medical device, the caregiver may spread illness or disease from room to room. More specifically, a caregiver may accidentally deposit germs (e.g., bacteria, viruses, and so forth) on the medical device while manipulating the device's controls. These germs may then be spread to the patient when a subsequent caregiver touches the medical device and then touches the patient. Moreover, if medical devices are moved from one patient room to another, germs transferred to the medical device via touch may be carried from one patient room to another. Even in operating rooms where medical devices are typically static, germs may be transferred onto a medical device during one surgery and subsequently transferred off the medical device during a later performed surgery.

Second, beyond contamination, medical devices that rely on physical contact for command input may clutter the caregiver's workspace. For example, because the medical device must be within an arm's length of the caregiver, the medical device may crowd the caregiver—potentially even restricting free movement of the caregiver. In addition, caregivers may have difficulty manipulating controls with gloved hands. For example, it may be difficult to grasp a knob or press a small button due to the added encumbrance of a glove.

Third, current trends in general medical device design focus on miniaturizing overall medical device size. However, as controls which rely on physical contact must be large enough for most, if not all, caregivers to manipulate with their hands, medical devices that employ these types of controls are limited in their possible miniaturization. For example, even if it were possible to produce a conventional oximeter that was the size of a postage stamp, it would be difficult to control this theoretical postage stamp-sized pulse oximeter with currently available techniques.

### BRIEF DESCRIPTION OF THE DRAWINGS

Advantages of the invention may become apparent upon reading the following detailed description and upon reference to the drawings in which:

FIG. 1 is a diagrammatical representation of a medical device featuring an integral microphone in accordance with one embodiment of the present invention;

FIG. 2 is a diagrammatical representation of a medical device featuring an external microphone in accordance with one embodiment of the present invention;

FIG. 3 is a flow chart illustrating an exemplary technique for secure user identification in accordance with one embodiment of the present invention;

FIG. 4 is a block diagram of a medical device configured for secure user identification in accordance with one embodiment of the present invention;

FIG. 5 is a diagrammatical representation of a medical device featuring an biometric reader in accordance with one embodiment of the present invention; and

FIG. 6 is a diagrammatical representation of a patient room containing a plurality of patients and a plurality of medical devices in accordance with one embodiment of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

For at least the reasons set forth above, an improved system or method for interacting with a medical monitoring device would be desirable. A possible solution for resolving one or more of the issues set forth above involves issuing voice commands to the medical device rather than physically manipulating controls. However, this solution raises new concerns.

First, the medical device should not react to simple complaints from patients or visitors. Medical devices often have loud alarms to alert caregivers that something requires their attention. If an alarm sounds, the patient or a visitor typically should not be allowed to tell the medical device to quiet the alarm. In addition, it may be desirable to prevent some medical personnel from performing all of the functions on a given medical device. For example, an orderly typically may not be able to command a medical device to alter a patient's treatment.

Second, in medical devices that store patient information, security measures typically should ensure patient privacy. Some medical devices store historical data on the patient which the caregiver can reference for comparisons. For example, a pulse oximeter may record trends in the patient's blood-oxygen saturation level, so that a caregiver can determine whether treatment is improving the patient's condition. Accordingly, it may be desirable to allow only certain personnel to access the patient's medical history.

One or more of the embodiments set forth below may be directed towards one or more of the issues discussed above.

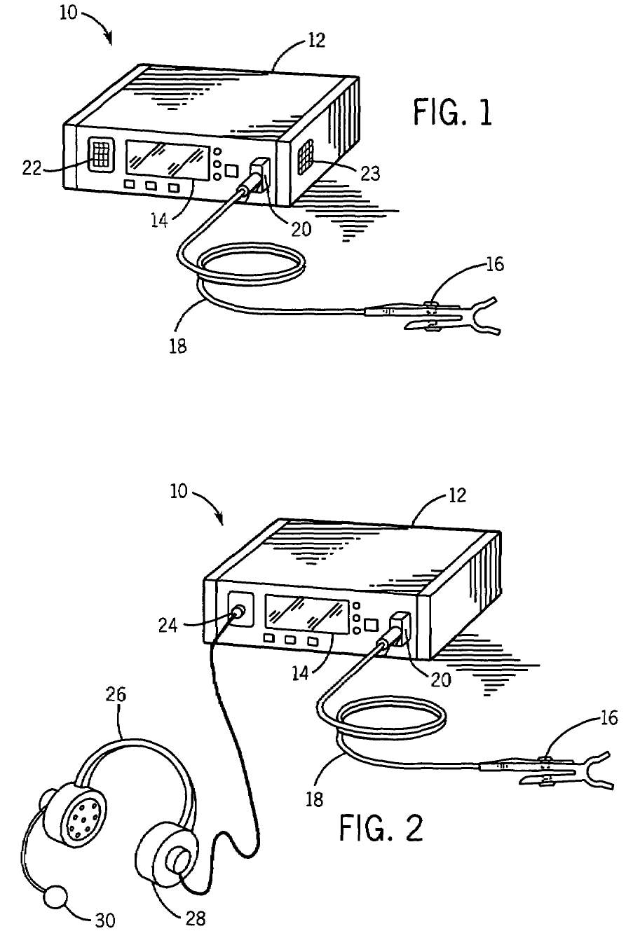

Turning initially to FIG. 1, an exemplary medical device featuring an integral microphone in accordance with one embodiment is illustrated and generally designated by the reference numeral 10. For example, in the illustrated embodiment, the medical device 10 comprises a pulse oximeter. The medical device 10 may include a main unit 12 that houses hardware and/or software configured to calculate various physiological parameters. As illustrated, the main unit 12 may include a display 14 for displaying the calculated physiological parameters, such as oxygen saturation or pulse rate, to a caregiver or patient. In alternate embodiments, as described in further detail below, the display 14 may be omitted from the main unit 12.

The medical device 10 may also include a sensor 16 that may be connected to a body part (e.g., finger, forehead, toe, or earlobe) of a patient or a user. The sensor 16 may be configured to emit signals or waves into the patient's or user's tissue and detect these signals or waves after dispersion and/or reflection by the tissue. For example, the sensor 16 may be configured to emit light from two or more light emitting diodes (“LEDs”) into pulsatile tissue (e.g., finger, forehead, toe, or earlobe) and then detect the transmitted light with a light detector (e.g., a photodiode or photo-detector) after the light has passed through the pulsatile tissue.

As those of ordinary skill in the art will appreciate, the amount of transmitted light that passes through the tissue generally varies in accordance with a changing amount of blood constituent in the tissue and the related light absorption. On a beat-by-beat basis, the heart pumps an incremental amount of arterial blood into the pulsatile tissue, which then drains back through the venous system. The amount of light that passes through the blood-perfused tissue varies with the cardiac-induced cycling arterial blood volume. For example, when the cardiac cycle causes more light-absorbing blood to be present in the tissue, less light travels through the tissue to strike the sensor's photo-detector. These pulsatile signals allow the medical device 10 to measure signal continuation caused by the tissue's arterial blood, because light absorption from other tissues remains generally unchanged in the relevant time span.

In alternate embodiments, the sensor 16 may take other suitable forms beside the form illustrated in FIG. 1. For example, the sensor 16 may be configured to be clipped onto a finger or earlobe or may be configured to be secured with tape or another static mounting technique. The sensor 16 may be connected to the main unit 12 via a cable 18 and a connector 20.

The medical device 10 may also include an integral microphone 22. As will be described further below, the integral microphone 22 may be configured to receive voice commands from a caregiver or user that can be processed into commands for the medical device 10. Although FIG. 1 illustrates the integral microphone 22 as being located on a front façade of the main unit 12, it will be appreciated that in alternate embodiments, the integral microphone 22 may be located at another suitable location on or within the main unit 12.

The medical device 10 may also include a speaker 23, which may be configured to broadcast alerts to a caregiver or user. Although FIG. 1 illustrates the speaker 23 as being located on a side façade of the main unit 12, it will be appreciated that in alternate embodiments, the speaker 23 may be located at another suitable location on or within the main unit 12.

Turning next to FIG. 2, another embodiment of the exemplary medical device 10 featuring an external microphone and speaker in accordance with one embodiment. For simplicity, like reference numerals have been used to designate those features previously described in regard to FIG. 1. As illustrated in FIG. 2, the medical device 10 includes the main unit 12, the screen 14, the sensor 16, the cable 18, and the connector 20. However, in place of or in addition to the integral microphone 22, the medical device 10 illustrated in FIG. 2 includes an audio connector 24 suitable for coupling a head set 26 to the main unit 12.

As illustrated in FIG. 2, the headset 26 may include one or more speakers 28 and an external microphone 30. As will be described further below, the one or more external speakers 28 may be employed by the medical device 10 to broadcast suitable alerts to a caregiver or user. In addition, the external microphone 30 may be employed to receive voice commands for the medical device 10.

As will be described further below, the medical device 10 may be configured to execute voice commands from users, such as caregivers. However, as will be appreciated, many other unauthorized individuals (e.g., patients, guests) may also try to give voice commands to the medical device. For example, a patient, annoyed with an alert, may try to use voice commands to silence an alert before the caregiver hears the alarm. Alternatively, a conversation around the medical device could be interpreted by the medical device 10 as a voice command. For example, the medical device 10 could accidentally interpret the question “When will my ventilator be turned off,” as command to turn off the patient's ventilator. This is clearly undesirable.

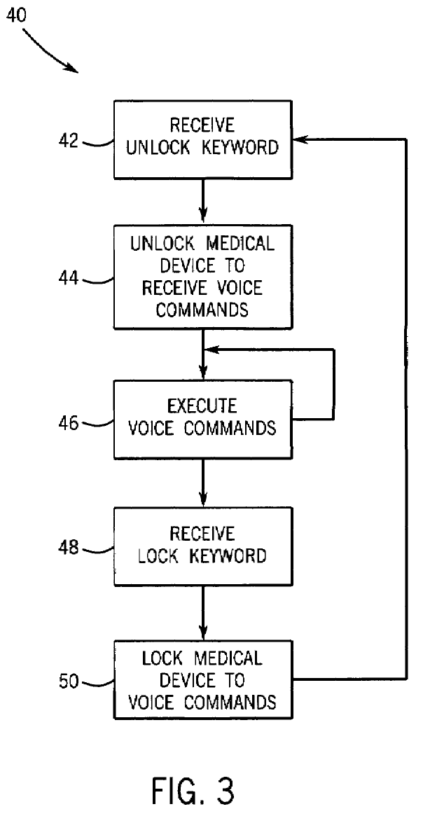

For at least these reasons, the medical device 10 may be configured to prevent unauthorized or accidental voice commands from occurring. For example, FIG. 3 is a flow chart illustrating an exemplary technique 40 for secure user identification in accordance with one embodiment. In particular, as described further below, the technique 40 may include using one or more sounds and/or keywords to unlock and/or lock a voice interface on the medical device 10. When voice interface is locked, authorized or accidental commands would be ignored, but when a caregiver unlocks medical device 10, it would be free to accept and execute voice commands. In one embodiment, the technique 40 may be executed by the medical device 10. However, in alternate embodiments, other suitable medical devices may be configured to execute the technique 40

The technique 40 may begin by receiving an “unlock” keyword or sound, as indicated by block 42. For example, in one embodiment, the keyword may be a simple word, such as “unlock” or “start.” However, in alternate embodiments, the keyword may be a more linguistically complex word, such as a nonsensical or foreign word to discourage unauthorized access to the medical device. In one embodiment, the medical device 10 may recognize a keyword using the techniques for voice recognition set forth in commonly assigned U.S. patent application Ser. No. ______ entitled SYSTEM AND METHOD FOR INTEGRATING VOICE WITH A MEDICAL DEVICE and filed on Sep. 29, 2006, which is hereby incorporated by reference.

After receiving the unlock keyword, the technique 40 may include unlocking a voice interface of the medical device 10 to voice commands, as set indicated in block 44. For example, in one embodiment, the medical device 10 may start to execute voice commands after receiving the unlock keyword. After the medical device 10 has been unlocked, the technique 40 may continue by executing subsequent voice commands, as indicated by block 46.

As illustrated in FIG. 3, the technique 40 may continue to execute voice commands until a “lock” keyword is received, as indicated by block 48. In various embodiments, the lock keyword may be the same as the unlock keyword or it may be different. For example, the words “unlock” and “lock” may be used or a single foreign word may be used to both unlock and lock the medical device 10. After the lock keyword is received, the technique 40 may lock the medical device 10 to future voice commands until the unlock keyword is received again, as indicated by block 50.

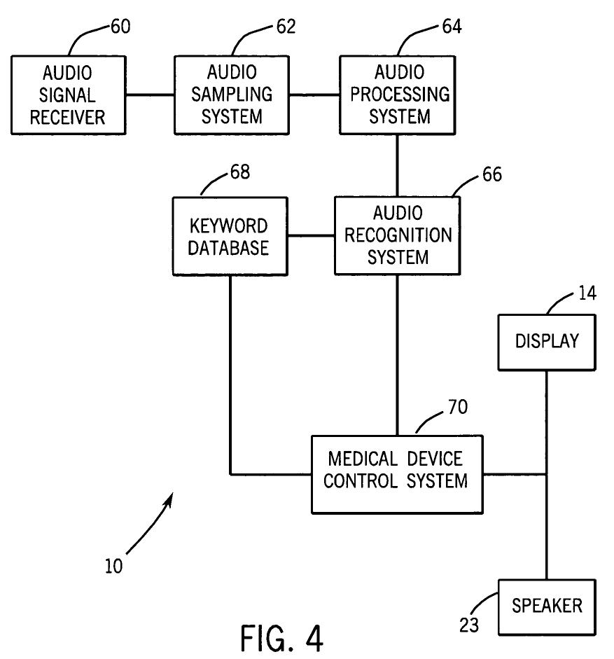

As described above, the medical device 10 may be configured to unlock and/or lock its voice interface based on one or more keywords. Accordingly, FIG. 4 is a block diagram of the medical device 10 configured for secure user identification in accordance with one embodiment. For simplicity, like reference numerals have been used to designate those features previously described with regard to FIGS. 1 and 2. As illustrated in FIG. 4, the medical device 10 may include a plurality of modules (blocks 60-70). These modules may be hardware, software, or some combination of hardware and software. Additionally, it will be appreciated that the modules shown in FIG. 4 are merely one example and other embodiments can be envisaged wherein the module functions are split up differently or wherein some modules are not included or other modules are included. Moreover, it will be appreciated that the blocks 60-70 may be employed in a plurality of other suitable medical devices in addition to the medical device 10. For example, the blocks 60-70 may be employed in respirators, ventilators, electroencephalogram (“EEG”) devices, medical cutting devices, and so-forth.

As illustrated in FIG. 4, the medical device 10 may include an audio signal receiver 60. The audio signal receiver 60 may include any suitable form of microphone or voice recording device, such as the integral microphone 22 (illustrated in FIG. 1) or the external microphone 30 (illustrated in FIG. 2). As those of ordinary skill in the art will appreciate, the audio signal receiver 60 may be configured to receive an audio signal (i.e., an acoustic wave) and to convert the audio signal into an electronic analog waveform.

The audio signal receiver 60 may be configured to transmit the analog electrical wave to an audio sampling system 62. The audio sampling system 62 may be configured to sample the electronic analog waveform to create digital voice data. For example, in one embodiment, the audio sampling system 62 may be configured to sample the electronic analog waveform 16,000 times per second to create a digital waveform of pulse amplitudes. In alternate embodiments, other suitable sampling techniques may be employed.

An audio processing system 64 may be configured to receive the digital waveform and to convert the digital waveform into frequencies that can be recognized by an audio recognition system 66. In one embodiment, the audio processing system 64 may be configured to perform a fast fourier transform on the incoming digital waveform to generate a plurality of frequencies. The audio processing system 64 may then transmit the plurality of frequencies to the audio recognition system 66.

The audio recognition system 66 may be pre-populated or programmed with a plurality of frequency combinations that are associated with commands for the medical device 10. For example, frequency combinations associated with the audio command “turn off alarm” may be associated with a command for the medical device 10 to silence an alarm. As mentioned above, in one embodiment, the particular frequency combinations may be pre-programmed or pre-configured. However, in alternate embodiments, the frequency combinations may be programmed into the audio recognition system by another suitable system.

In addition, besides recognizing a command for the oximeter 10, the audio recognition system 66 may be configured to identify keywords to unlock and/or lock the voice interface of the medical device 10. For example, the audio recognition system 66 may be configured to access a keyword database 68 and to compare spoken combinations of frequencies as keywords that unlock and/or lock the medical device 10. As such, the audio recognition system 66 may be configured to instruct a medical device control system 70 to accept voice commands after an unlock keyword is spoken and/or to stop executing voice commands after a lock keyword is spoken.

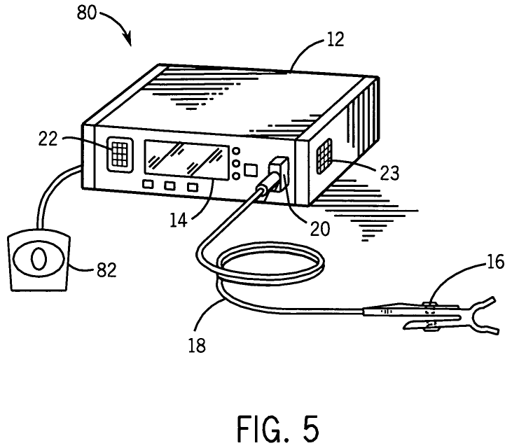

In another embodiment, a medical device may employ one or more suitable forms of biometric recognition to unlock and/or lock itself. For example, FIG. 5 is a diagrammatical representation of a medical device 80 featuring a biometric reader 82 in accordance with one embodiment. For simplicity, like reference numerals have been used to designate those features previously described in relation to FIGS. 1 and 2. As illustrated by FIG. 5, the medical device 80 may include the main unit 12, the display 14, the sensor 16, the cable 18, the connector 20, the microphone 22, and the speaker 23, as outlined above.

In addition, the medical device 80 may include the biometric reader 82, which may be configured to recognize a biometric signature of a user (e.g., fingerprint, eye shape, facial contours, and the like). The biometric reader 82 may be configured to unlock and/or lock the medical device 80 to voice commands based on the biometric signature. In one embodiment, the biometric reader 82 may include a fingerprint scanner. In another embodiment, the biometric reader 82 may comprise a retinal scanner configured to conditioned access based upon the shape of a user's eye. In still other embodiments, the biometric reader 82 may comprise a video camera configured to conditioned access based on one or more facial or body features. In yet another embodiment, the biometric reader 82 may include an optical spectrometer.

In yet another embodiment, the biometric reader 82 may be configured to recognize a user voiceprint. For example, the biometric reader 82 may be configured to be able to receive and recognize an authorized user by their voice. Accordingly, in this embodiment, the medical device may be configured to unlock when it detects an authorized user voice and to lock in the absence of that voice. It will be appreciated, however, that the above-described examples of the biometric reader 82 are merely exemplary, and, as such, not intended to be exclusive. Accordingly, in other embodiments, other alternate suitable biometric readers 82 may be employed.

As described above, the medical device 10 may be configured to execute voice commands from caregivers. As will be appreciated, however, modern patient rooms, operating rooms, doctors' offices, and the like, include a plurality of different medical devices. For example, a patient's room may have a pulse oximeter, a respirator, and a multi-parameter monitoring system. Moreover, a single patient room may include multiple patients and, as such, multiple incarnations of each device, which are each configured to employ voice commands. Although such a configuration is advantageous from a cross-contamination standpoint, having multiple medical devices that each accept voice commands may introduce some measure of confusion between the medical devices. For example, a voice command directed to an oximeter to “turn off” could be executed by a ventilator with disastrous results. Alternatively, an unlock command to one pulse oximeter in a patient's room may be received by another pulse oximeter in the same room—allowing potentially unauthorized access to the other pulse oximeter. For at least these reasons, one or more of the embodiments set forth below may be directed toward identification and specification of voice commands for a particular medical device.

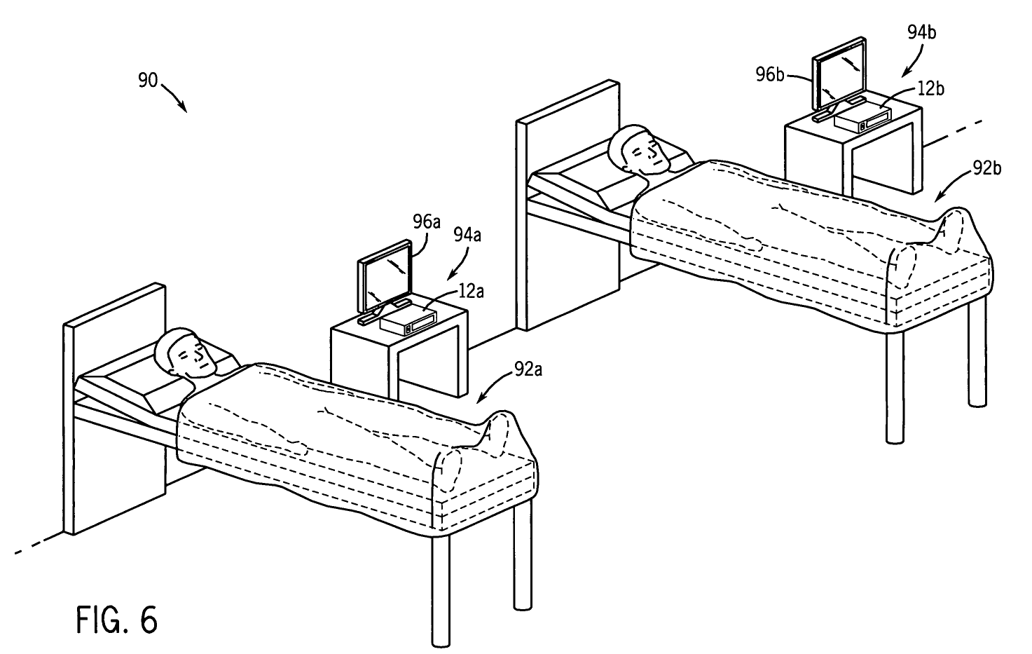

FIG. 6 is a diagrammatical representation of a patient room 90 containing a plurality of patients 92a and 92b and a plurality of medical devices 94a and 94b in accordance with one embodiment. As illustrated, the medical devices 94a and 94b may include the main units 12a and 12b, as described above with regard to FIGS. 1 and 2 as well as external screens 96a and 96b. Although the patient room 90 is illustrated as including one medical device 94a corresponding to the patient 92a, and one medical device 94b corresponding to the patient 92b, it will be appreciated that this configuration and correspondence is merely exemplary. As such, in alternate embodiments, the patients 92a and 92b may each be supported by a plurality of similar and/or different medical devices.

As described above, the voice commands from a caregiver directed towards the medical device 94a, for example, may be received by the medical device 94b. As such, the medical devices 94a and 94b may be configured to employ preparatory identification commands. More specifically, in one embodiment, the medical devices 94a and 94b may be configured to only execute those voice commands preceded by a medical device specific identifier. For example, in one embodiment, each of medical devices 94a and 94b may have a unique numerical designation. In this embodiment, a caregiver may direct voice commands to the medical device 94a by prefacing voice commands with the number one and may direct voice commands to the medical device 94b by prefacing commands with the number two.

In one embodiment, the medical devices 94a and 94b may also include labels that visually designate their unique identifiers to the caregiver. For example, the medical device 94a may have a large sticker with the number one and the medical device 94b have a large sticker with the number two. It will be appreciated, however, that numerical identifiers are merely one suitable type of unique identifier. As such, in alternate embodiments, the medical devices 94a and 94b may be assigned other suitable numbers, letters, words, and so-forth. For example, each of the medical devices 94a and 94b may be assigned a unique name to identify it.

In still other embodiments, other techniques for identifying the target medical device 10 for a voice command may be employed. For example, in one embodiment, the medical devices 94a and 94b may include a sensor configured to receive a laser or other light beam. In this embodiment, the caregiver may use a laser pointer to designate the intended medical device. For example, medical devices 94a and 94b may be configured to receive voice commands and/or unlock (as described above) when the caregiver directs a laser beam at that particular medical device 94a and 94b. In this way, medical devices 94a and 94b will only execute those voice commands intended for them.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims. Indeed, as described above the present techniques may not only be applied to pulse oximeters, but also to a number of other suitable medical devices

What is claimed is:

1. A method comprising:
receiving an unlock sound for a medical device;
unlocking the medical device to voice commands in response to receiving the unlock sound; and
executing one or more voice commands on the medical device after the medical device is unlocked.

2. The method, as set forth in claim 1, comprising:
receiving a lock sound for the medical device; and
locking the medical device to subsequent voice commands.

3. The method, as set forth in claim 2, wherein the lock sound and the unlock sound are different words.

4. The method, as set forth in claim 1, wherein receiving the unlock sound comprises receiving a non-english word.

5. The method, as set forth in claim 4, The method, as set forth in claim 1, wherein receiving the unlock sound comprises receiving a nonsensical word.

6. The method, as set forth in claim 1, wherein unlocking the medical device to voice commands comprises unlocking a pulse oximeter to voice commands.

7. A medical device comprising:
an audio recognition system configured to receive an unlock keyword for the medical device; and to unlock the medical device to voice commands in response to the unlock keyword; and
a control system coupled to the audio recognition system configured to execute one or more voice commands on the medical device after the medical device is unlocked.

8. The medical device, as set forth in claim 7, wherein the audio recognition is configured to receive a lock keyword for the medical device and wherein the control system is configured to lock the medical device in response to the lock keyword.

9. The medical device, as set forth in claim 7, wherein the medical device comprises a pulse oximeter.

10. A medical device comprising:
a biometric reader configured to recognize a biometric signature of an authorized user; and
a control system configured to execute voice commands in response to the biometric reader recognizing the authorized user.

11. The medical device, as set forth in claim 10, wherein the biometric reader comprises a fingerprint scanner.

12. The medical device, as set forth in claim 10, wherein the biometric reader comprises a retinal scanner.

13. The medical device, as set forth in claim 10, wherein the biometric reader comprises a camera.

14. The medical device, as set forth in claim 10, wherein the medical device comprises a pulse oximeter.

15. The medical device, as set forth in claim 10, wherein the biometric reader comprises an optical spectrometer.

16. A medical device configured to execute voice commands preceded by a unique identifier associated with the medical device, wherein the medical device is configured to ignore voice commands not preceded by the unique identifier.

17. The medical device, as set forth in claim 16, wherein the unique identifier comprises a numerical designation.

18. The medical device, as set forth in claim 17, comprising a label comprising the numerical designation associated with the medical device.

19. The medical device, as set forth in claim 16, wherein the medical device comprises a pulse oximeter.

20. A medical device comprising:
a laser sensor configured to detect the presence of a laser beam on the laser sensor; and
a control system coupled to the laser sensor and configured to execute voice commands after the laser sensor has detected the presence of the laser beam.

21. The medical device, as set forth in claim 20, wherein the control system is configured to only execute commands while the laser is detecting the presence of the laser beam.
